(19) United States
(12) Patent Application Publication
(10) Pub. No.: US 2019/0048866 A1
(43) Pub. Date: Feb. 14, 2019

(54) PUMP ARRANGEMENT

(71) Applicant: HANNING ELEKTRO-WERKE GmbH & Co. KG, Oerlinghausen (DE)

(72) Inventor: Harald Buchalla, Soest (DE)

(21) Appl. No.: 16/157,570

(22) Filed: Oct. 11, 2018

Related U.S. Application Data
(62) Division of application No. 14/787,045, filed on Oct. 26, 2015, now abandoned.

(30) Foreign Application Priority Data
May 23, 2013 (DE) 10 2013 105 288.6

(51) Int. Cl. F04B 43/09; F04B 43/00; F04B 43/12

(52) U.S. Cl. CPC F04B 43/09; Y02B 30/66; F25B 21/00; F04B 43/12; F04B 43/0072

(57) ABSTRACT

A pump arrangement having a unit which comprises a material with a magnetocaloric action, an arrangement of conduits which are in the region of the unit and through which a liquid or gaseous heat-conduction medium flows and a pump system operating according to travelling-wave principles.

### BACKGROUND OF THE INVENTION

### Field of the Invention

Devices using the “magnetocaloric effect” phenomenon to work as heat pumps have been known for quite some time. In these devices, materials which have the magnetocaloric effect are periodically exposed to a magnetic field. Under the influence of the magnetic field, the specific heat capacity or thermal storage capacity of the material changes.

By supplying and discharging media (gases, liquids), the device may be supplied with thermal energy, which can be transformed to a different temperature level and then be discharged. For the supply and discharge of media, pump systems are required. These pump systems must operate with low-maintenance and good efficiency. In the following, a pump system is disclosed which is particularly well suited for this application.

### Description of the Related Art

FIG. 1 shows an assembly 1, to which a medium having a temperature δ₁ is supplied, and from which a medium with temperature δ₂ is discharged. In order to produce the effect of temperature transformation, preferably rotary energy is input into such an assembly. Due to the relatively large thermal time constants of the components used in the units, the rotational frequency of the rotational motion induced in the assembly by external drives must be low (in particular between 0.5 Hz and 20 Hz, preferably in the range of 1 Hz to 10 Hz). These external drives can be formed, for example, by a combination of distinctly faster running, generally cylindrical shaped, electric motor 2 and a reduction gear 3.

A distinctly disc-shaped, slow-running motor 4 is significantly more compact, quieter, lower-maintenance and more energy efficient. The motor 4 can be particularly advantageously designed as a multi-pole axial flux motor. In FIG. 2, such a motor is illustrated as an asymmetrical (one sided) axial flow motor. It is designed as a synchronous motor and consists of a stator 5 and a rotor 6. A torque, and thus rotational motion, is generated in the permanent magnets 7 fixed to the rotor 6 by applying a rotating field to the coils 8. The torque can be transferred via the shaft 9.

FIG. 3 shows an analogous device in the form of a symmetrical structured double-sided axial flow device. Also suitable for the above purpose is the use of a permanent magnet synchronous device according to the external rotor principle (see FIG. 4). Characteristic of both engine variants is the cavity between the rotor and stator.

### BRIEF SUMMARY OF THE INVENTION

The invention is accomplished with a pump arrangement for a device with a material having a magnetocaloric effect, the pump arrangement comprising: a conduit arranged in an area of the device through which conduit a liquid or gaseous heat transfer medium flows, a multi-pole axial flux electrical motor having a disc-shaped rotor rotatably, mounted on a shaft for rotation about an axis of rotation, and a disc-shaped stator, wherein the rotor is provided permanent magnets, wherein the stator is provided electrical coils, wherein the permanent magnets and coils are provided coaxially on the same plane relative to the axis of rotation, and a pump system at least partially integrated in a space formed between the rotor and the stator of the electrical motor, the pump system including an inlet and an outlet in communication with the conduit arranged in the area of the device through which a liquid or gaseous heat transfer medium flows and in communication with a tubular membrane provided on the stator, a cam provided on the rotor, the cam in contact with the tubular membrane, wherein rotational movement of the rotor relative to the stator causes the cam to pass periodically over the tubular membrane causing the liquid or gaseous heat transfer medium to be conveyed on the traveling wave principle from inlet to outlet.

### BRIEF DESCRIPTION OF THE SEVERAL VIEWS OF THE DRAWINGS

Further details, features and advantages of the invention become apparent from the following description of exemplary embodiments with reference to the drawing, in which:

FIG. 1 shows an assembly 1, to which a medium having a temperature δ₁ is supplied, and from which a medium with temperature δ₂ is discharged;

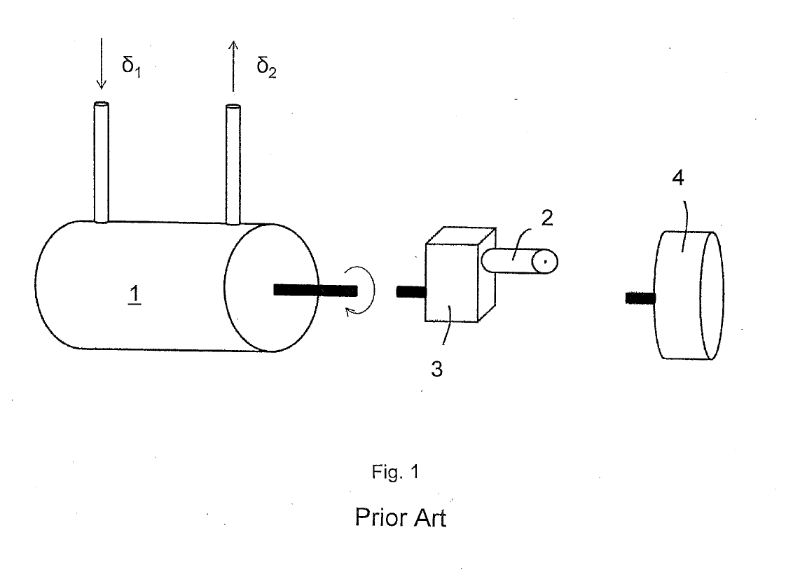

FIG. 2 shows a motor as an asymmetrical (one sided) axial flow motor;

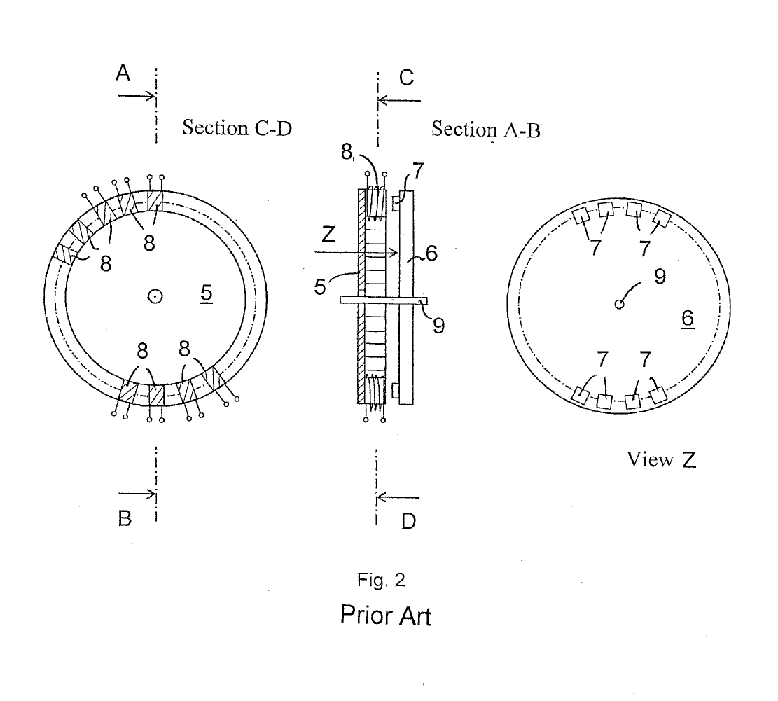

FIG. 3 shows an analogous device in the faun of a symmetrical structured double-sided axial flow device.

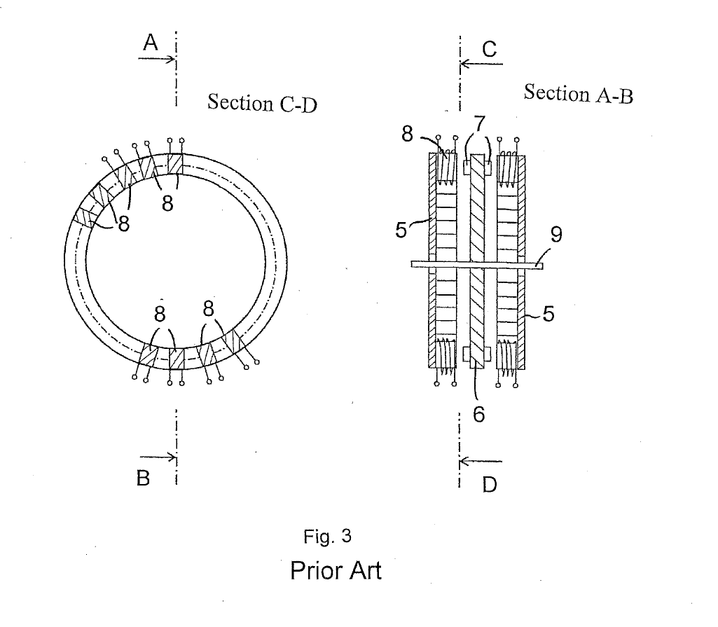

FIG. 4 shows a permanent magnet synchronous device according to the external rotor principle;

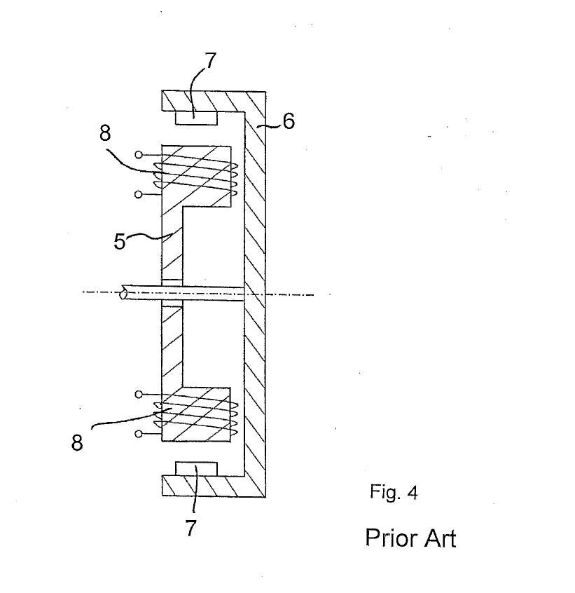

FIG. 5 shows a pump system in an annular groove on the stator 5 according to the traveling wave principle.

FIG. 6 shows a further development of the arrangement with two independent media circulations via another concentric membrane assembly and another cam;

FIG. 7 shows a further development of the previous arrangement for a symmetrical (two-sided) designed axial flow;

FIG. 8 shows radially a circumferentially segmented arrangement;

FIG. 9 shows an arrangement with a plurality of cams per orbit;

FIG. 10 shows further locations for the membrane assemblies; and

FIG. 11 shows analogous conceivable positions of membrane assemblies in a permanent magnet synchronous machine according to the external rotor principle.

### DETAILED DESCRIPTION OF THE INVENTION

The gap between the rotor and stator is in this case a particularly good way to house one or more pumps for transporting the heat conducting medium.

Considering the optimal spatial and functional integration of the entire assembly and in view of the set drive characteristics with the low speed, it has been shown to be advantageous to make use of pump systems working on the traveling wave principle. Such pump systems are described for example in the European patent EP 1317626 B1.

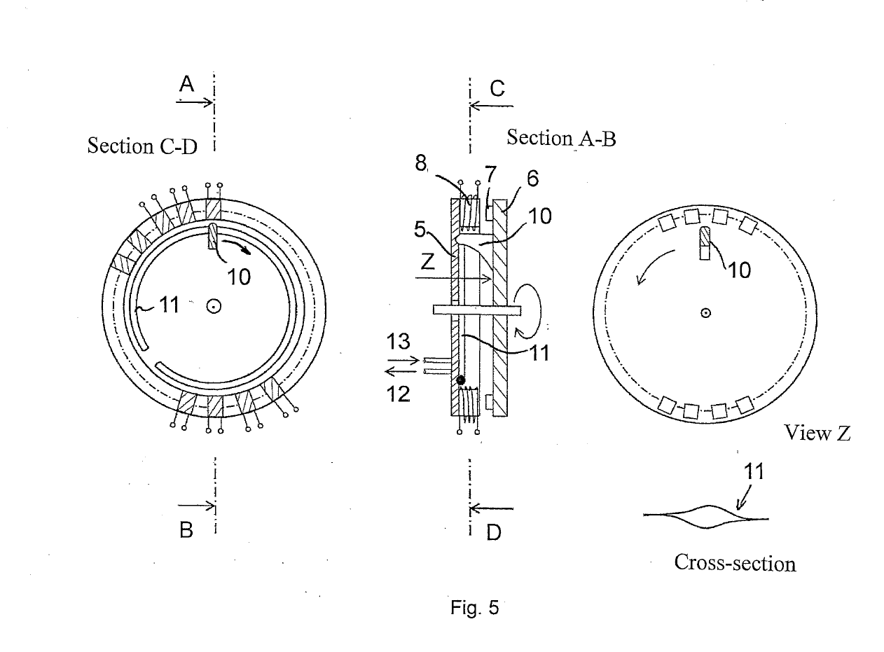

FIG. 5 shows how to put a pump system in an annular groove on the stator 5 according to the traveling wave principle. By the rotational movement of the rotor 6, the cam 10 periodically passes over the membrane assembly 11, whereby a liquid or gaseous medium can be conveyed via the connections 12 and 13. The cross-section of the tubular membrane arrangement 11 corresponds to the arrangement described in the European patent EP 1317626 B1. The pump can be operated virtually without wear and is virtually maintenance-free, quiet and efficient. In accordance with the principle of the traveling wave pump, no seals on moving parts are needed. Since little friction occurs between the cam 10 and diaphragm assembly 11, the components involved are hardly subject to wear. As this pump arrangement can work by displacement or as a flow pump (e.g., via adjustable cam height), a wide range of pressure levels, for example in the range from 10 mbar to 20 bar, can be realized. Further, a not shown means for providing a variable magnetic field is provided.

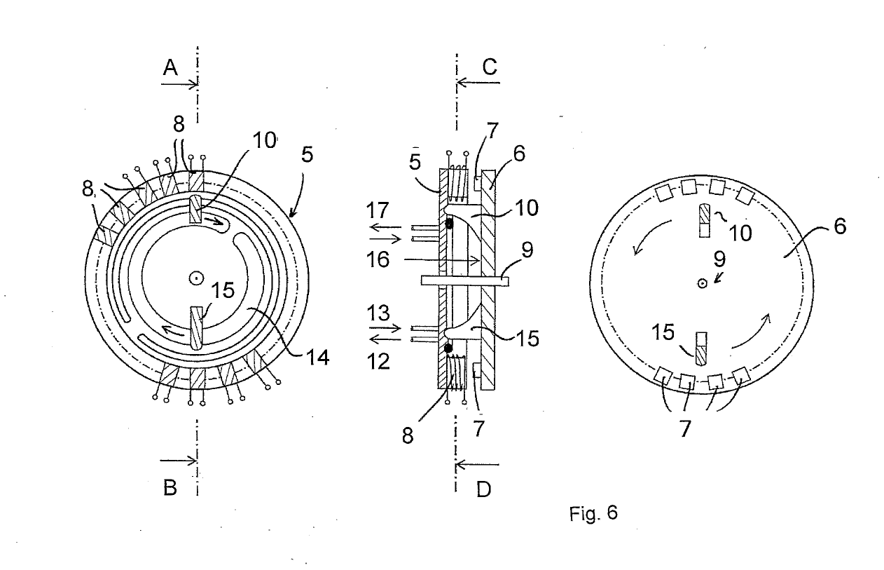

FIG. 6 shows a further development of the arrangement with two independent media circulations via another concentric membrane assembly 14 and another cam 15. Via the connections 16 and 17 another media circuit can operate. Furthermore, FIG. 6 shows that the membrane assemblies 11 and 14 would also be possible in different cross-sections (widths, heights). Therewith, for example, the different radial rotational speeds of the cam can be compensated to achieve the same flow rates in both circuits. However other mixed modes with different flow rates or pressure levels can be realized.

Similarly, further, in particular concentric, arrangements for other circuits are conceivable and possible.

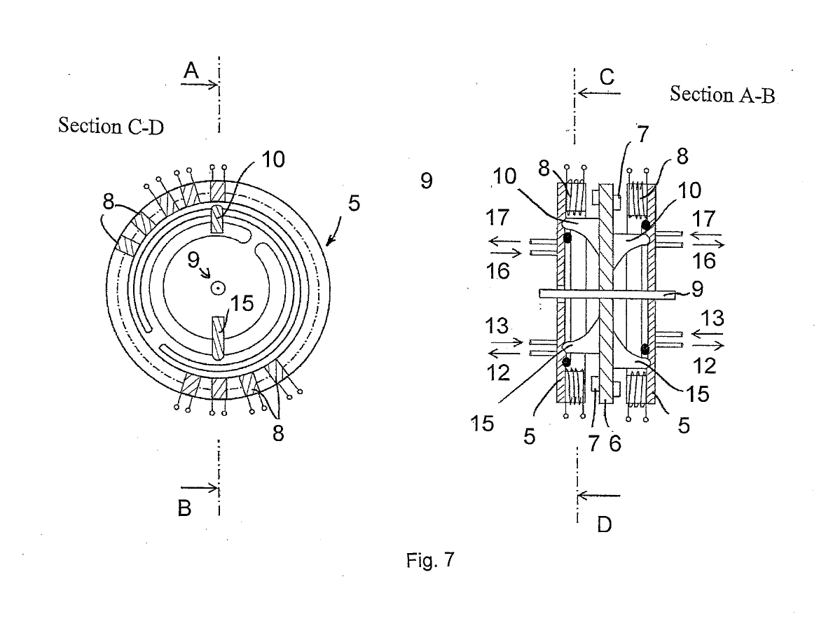

FIG. 7 shows a further development of the previous arrangement for a symmetrical (two-sided) designed axial flow, which as stated above can be realized in different variants.

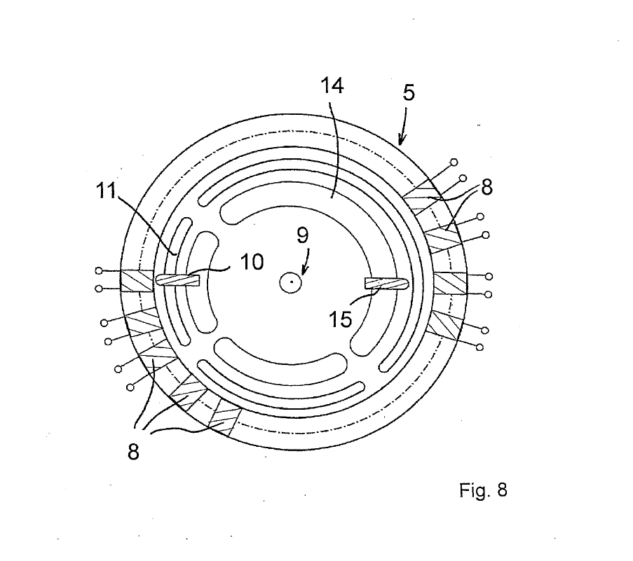

FIG. 8 shows radially a circumferentially segmented arrangement. Segmentation can be implemented in any number and shape.

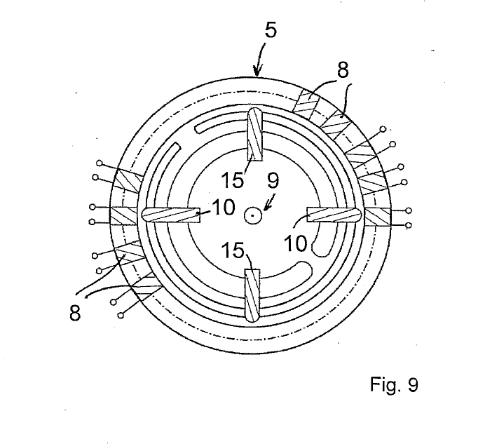

FIG. 9 shows an arrangement with a plurality of cams per orbit (any number and shape imaginable).

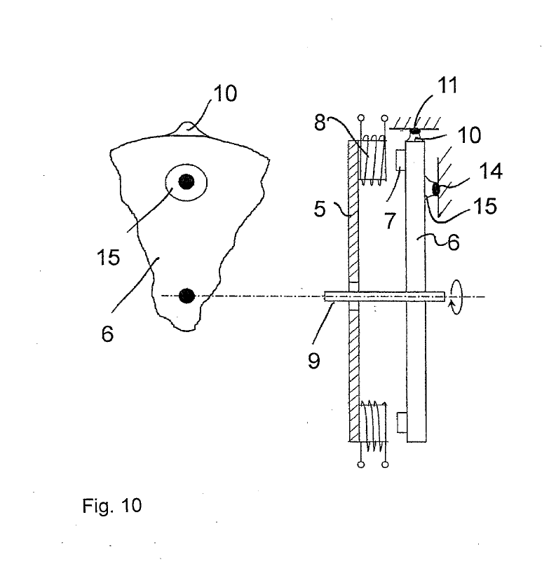

FIG. 10 shows further locations for the membrane assemblies.

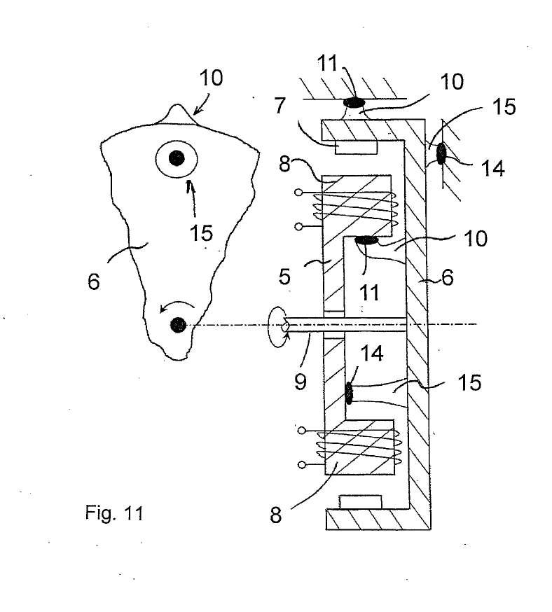

FIG. 11 shows analogous conceivable positions of membrane assemblies in a permanent magnet synchronous machine according to the external rotor principle.

If a motor of a different design, for example by the internal rotor principle is used, the considerations are analogous between two plane-parallel plates or between respective radial hollow spaces between an inner and an outer wall of two cylindrical assemblies in or on the magnetocaloric unit.

In particular, it may be provided that, to improve efficiency of the arrangements, measures may be taken to reduce the friction and in particular between the membrane 11, 14 and the cams 10, 15. To that extent, the already low friction be further improved by the provision of rollers or by improving the sliding property—for example by coating the membrane 11, 14 respectively or the cams 10, 15.

The disclosed embodiments of the invention can be combined. They are each an example, of which individual features of the embodiments by themselves are or may be essential to the invention. In addition, the pump system is merely exemplary housed in the gap between the rotor and the stator. Basically, the pump system can be arranged between any relatively moving components of the pump assembly or the drive unit. Further, the motor can be positioned to the side of the assembly or be integrated within the assembly at any point. In this respect, there results an integrated implementation with small space.

The invention is particularly directed to a pump arrangement comprising a device with a material having a magnetocaloric effect, a conduit arranged in the area of the device through which a liquid or gaseous heat transfer medium flows, and a pump system operating on the traveling wave principle, preferably characterized in that the pump system is provided spatially integrated into the working unit, characterized in that the working unit has a rotating working electrical motor having a rotor and a stator and that the pump system is at least partially integrated in a space formed between the rotor and the stator of the electrical motor, and/or characterized in that means are provided for periodically providing a magnetic field.

The invention is also particularly direct to a method for conveying a heat conducting medium through an arrangement with a material having the magnetocaloric effect, comprising rotationally operating, at a rotational frequency in the range of 0.2 Hz to 20 Hz, preferably in the range of 1 Hz to 10 Hz, a pump system operating on the traveling wave principle and conveying the heat conducting medium, particularly characterized in that the material which has the magnetocaloric effect is periodically subjected to a magnetic field, and use of a pump system operating according to the principle of traveling wave for the promotion of a heat conducting medium through an arrangement with a material having a magnetocaloric effect and which is periodically exposed to a magnetic field.

1. A pump arrangement for a device with a material having a magnetocaloric effect, the pump arrangement comprising:
a conduit arranged in an area of the device through which conduit a liquid or gaseous heat transfer medium flows,
a multi-pole axial flux electrical motor having a disc-shaped rotor rotatably, mounted on a shaft for rotation about an axis of rotation, and a disc-shaped stator, wherein the rotor is provided permanent magnets, wherein the stator is provided electrical coils, wherein the permanent magnets and coils are provided coaxially on the same plane relative to the axis of rotation, and
a pump system at least partially integrated in a space formed between the rotor and the stator of the electrical motor, the pump system including
an inlet and an outlet in communication with the conduit arranged in the area of the device through which a liquid or gaseous heat transfer medium flows and in communication with a tubular membrane provided on the stator,
a cam provided on the rotor, the cam in contact with the tubular membrane,
wherein rotational movement of the rotor relative to the stator causes the cam to pass periodically over the tubular membrane causing the liquid or gaseous heat transfer medium to be conveyed on the traveling wave principle from inlet to outlet.

2. The pump arrangement according to claim 1, wherein the tubular membrane is provided on a radially inner surface of the stator and the cam is provided on an axial face of the rotor.

3. The pump arrangement according to claim 1, wherein means are provided for periodically subjecting the material having the magnetocaloric effect to a magnetic field.

4. The pump arrangement according to claim 1, wherein the tubular membrane is provided on an axial face of the stator and the cam is provided on an axial face of the rotor.

5. A pump arrangement for a device with a material having a magnetocaloric effect, the pump arrangement comprising:
a conduit arranged in an area of the device through which conduit a liquid or gaseous heat transfer medium flows,
a multi-pole axial flux electrical motor having a disc-shaped rotor and a disc-shaped stator, wherein the rotor is provided permanent magnets, wherein the stator is provided electrical coils, wherein the permanent magnets and coils are provided coaxially on the same plane,
a housing, and
a pump system at least partially integrated in a space formed between the rotor and the housing of the electrical motor, the pump system including
an inlet and an outlet in communication with the conduit arranged in the area of the device through which a liquid or gaseous heat transfer medium flows and in communication with a tubular membrane associated with the housing,
a cam provided on the rotor, the cam in contact with the tubular membrane,
wherein rotational movement of the rotor relative to the housing causes the cam to pass periodically over the tubular membrane causing the liquid or gaseous heat transfer medium to be conveyed on the traveling wave principle from inlet to outlet.

6. The pump arrangement according to claim 5, wherein the tubular membrane is provided on a radially inner face of the housing and the cam is provided on a radially outer face of the rotor.

7. The pump arrangement according to claim 5, wherein the tubular membrane is provided on an axially inner face of the housing and the cam is provided on an axially outer face of the rotor.

8. A pump arrangement for a device with a material having a magnetocaloric effect, the pump arrangement comprising:
a conduit arranged in an area of the device through which conduit a liquid or gaseous heat transfer medium flows,
a multi-pole axial flux electrical motor having a disc-shaped rotor and a disc-shaped stator, wherein the rotor is provided permanent magnets, wherein the stator is provided electrical coils, and
a pump system including
an inlet and an outlet in communication with the conduit arranged in the area of the device through which a liquid or gaseous heat transfer medium flows and in communication with a tubular membrane,
a cam provided on the rotor, the cam in contact with the tubular membrane,
wherein rotational movement of the rotor relative to the stator causes the cam to pass periodically over the tubular membrane causing the liquid or gaseous heat transfer medium to be conveyed on the traveling wave principle from inlet to outlet.

9. The pump arrangement according to claim 8, wherein the coils and permanent magnets are spaced axially.

10. The pump arrangement according to claim 9, wherein the tubular membrane is provided on a face of the stator and the cam is provided on a face of the rotor.

11. The pump arrangement according to claim 9, further comprising a pump housing, wherein the tubular membrane is associated with the housing, and wherein the cam is provided on an axial face of the rotor.

12. The pump arrangement according to claim 9, further comprising a pump housing, wherein the tubular membrane is associated with the housing, and wherein the cam is provided on a radial face of the rotor.
